(19) United States
(12) Patent Application Publication
(10) Pub. No.: US 2013/0283029 A1
(43) Pub. Date: Oct. 24, 2013

(54) ELECTRONIC APPARATUS, CONTROL METHOD OF ELECTRONIC APPARATUS, AND CONTROL PROGRAM OF ELECTRONIC APPARATUS

(71) Applicant: KABUSHIKI KAISHA TOSHIBA, Tokyo (JP)

(72) Inventor: Hiroshi Terada, Tokyo (JP)

(73) Assignee: KABUSHIKI KAISHA TOSHIBA, Tokyo (JP)

(21) Appl. No.: 13/763,191

(22) Filed: Feb. 8, 2013

(30) Foreign Application Priority Data
Apr. 23, 2012 (JP) 2012-098254

(51) Int. Cl. G06F 9/445

(52) U.S. Cl. CPC G06F 9/44505
USPC 713/100

(57) ABSTRACT

One embodiment provides an electronic apparatus, including: a connection detecting module configured to detect a connection of a preset external device to the electronic apparatus; and a first applying module configured to employ a preset first setting according to a preset data table upon the connection of the preset external device, the preset data table correlating the preset first setting with the connection of the preset first external device.

### CROSS-REFERENCE TO RELATED APPLICATION(S)

This application claims priority/priorities from Japanese Patent Application No. 2012-098254 filed on Apr. 23, 2012, the entire contents of which are incorporated herein by reference.

### FIELD

Embodiments described herein relate generally to an electronic apparatus, a control method of an electronic apparatus, and a control program of an electronic apparatus.

### BACKGROUND

An information processing apparatus (electronic apparatus) has been proposed which automatically prepares for use of an external peripheral device when it is connected to the electronic apparatus.

When the use environment has changed, the user needs to alter the PC settings of the electronic apparatus. It is troublesome for the user to alter the PC settings of the electronic apparatus so that they will be suitable for a new use environment. Thus, it is desired to make such alteration work less troublesome.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 shows an appearance of a notebook PC according to an embodiment.

FIG. 2 shows an internal configuration of the notebook PC.

FIG. 3 shows example use forms of the notebook PC.

FIG. 4 shows an operation of the notebook PC.

FIG. 5 shows a data table which is stored in a storage unit of the notebook PC.

FIGS. 6A-6C show how PC settings are made when an external device is connected to or disconnected from the notebook PC.

FIG. 7 shows an environment setting operation of the notebook PC which is performed when a TV receiver is connected to or disconnected from it.

FIG. 8 shows an environment setting operation of the notebook PC which is performed when a projector is connected to or disconnected from if.

FIG. 9 shows an operation of the notebook PC which is performed when the TV receiver is connected to or disconnected from it.

FIG. 10 shows an operation of the notebook PC which is performed when the projector is connected to or disconnected from it.

### DETAILED DESCRIPTION

One embodiment provides an electronic apparatus, including: a connection detecting module configured to detect a connection of a preset external device to the electronic apparatus; and a first applying module configured to employ a preset first setting according to a preset data table upon the connection of the preset external device, the preset data table correlating the preset first setting with the connection of the preset first external device.

An embodiment will be hereinafter described with reference to the drawings.

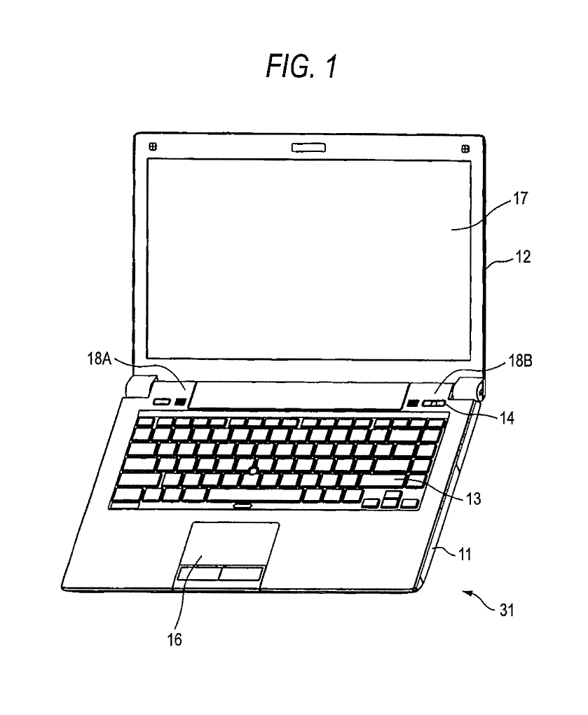

FIG. 1 shows an appearance of an electronic apparatus 31 according to the embodiment which is a notebook personal computer (PC). The concept of the embodiment can be applied to not only PCs but also TV receivers, cell phones, portable electronic devices, etc.

The notebook PC 31 is composed of a computer main body 11 and a video display unit 12. The video display unit 12 incorporates an LCD (liquid crystal display) 17, for example. The video display unit 12 is attached to the computer main body 11 so as to be rotatable between an open position where the video display unit 12 exposes the top surface of the computer main body 11 and a closed position where the video display unit 12 covers the top surface of the computer main body 11.

The computer main body 11 has a thin-box-shaped cabinet. A keyboard 13, a power button 14 for powering on/off the notebook PC 31, a touch pad 16, speakers 18A and 18B, etc. are arranged on the top surface of the cabinet.

The right side surface, for example, of the computer main body 11 is provided with a USB (universal serial bus) connector (not shown) for connection of a USB cable or a USB device of the USB 2.0 standard, for example.

The back surface of the computer main body 11 is provided with an external display connection terminal (not shown) which complies with the HDMI (high-definition multimedia interface) standard, for example. The external display connection terminal is used for outputting a digital video signal to an external display.

Although not shown, the notebook PC 31 is capable of booting up itself automatically at, for example, preset times to receive and record a broadcast program, receive mails etc., and check updates of a news site or the like.

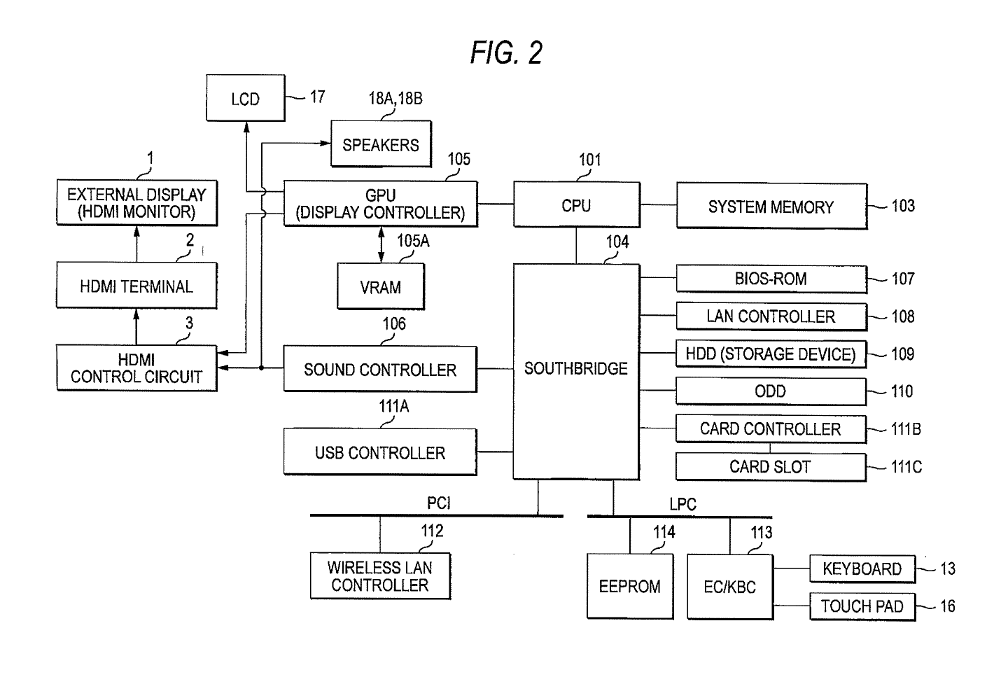

FIG. 2 shows an internal configuration of the notebook PC 31 according to the embodiment. As shown in FIG. 2, the notebook PC 31 is equipped with a CPU (central processing unit) 101, a system memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111B, a card slot 111C, a wireless LAN controller 112, an embedded controller/keyboard controller (EC/KBC) 113, an EEPROM (electrically erasable programmable ROM) 114, etc.

The CPU 101 is a processor for controlling the operations of the individual components of the notebook PC 31. The CPU 101 runs a BIOS which is stored in the BIOS-ROM 107. The BIOS is programs for hardware control. The CPU 101 incorporates a memory controller for access-controlling the system memory 103. The CPU 101 also has a function of communicating with the GPU 105 via, for example, a serial bus of the PCI Express standard.

The GPU 105 is a display controller for controlling the LCD 17 which is used as a display monitor of the notebook PC 31. A display signal generated by the GPU 105 is supplied to the LCD 17. The GPU 105 can also send a digital video signal to an external display 1 via an HDMI control circuit 3 and an HDMI terminal 2. The HDMI terminal 2 is the above-mentioned external display connection terminal. The HDMI terminal 2 makes it possible to send a non-compressed digital video signal and digital audio signal to the external display 1 such as a TV receiver through a single cable. The HDMI control circuit 3 is an interface for sending a digital video signal to the external display 1 (called an HDMI monitor) via the HDMI terminal 2.

The southbridge 104 controls individual devices on a PCI (peripheral component interconnect) bus and an LPC (low pin count) bus. The southbridge 104 incorporates an IDE (integrated drive electronics) controller for controlling the HDD 109 and the ODD 110. The southbridge 104 also has a function of communicating with the sound controller 106.

The sound controller 106, which is a sound source device, outputs reproduction subject audio data to the speakers 18A and 18B or the HDMI control circuit 3. The LAN controller 108 is a wired communication device for performing a wired communication of the IEEE 802.3 standard, for example. On the other hand, the wireless LAN controller 112 is a wireless communication device for performing a wireless communication of the IEEE 802.11g standard, for example. The USB controller 111A communicates with an external device that complies with the USB 2.0 standard, for example.

For example, the USB controller 111A is used for receiving an image data file that is stored in a digital camera. The card controller 111B writes and reads data to and from a memory card such as an SD card that is inserted in the card slot 111C which is provided in the computer main body 11.

The EC/KBC 113 is a one-chip microcomputer in which an embedded controller for power management and a keyboard controller for controlling the keyboard 13 and the touch pad 16 are integrated together. The EC/KBC 113 has a function of powering on/off the notebook PC 31 in response to a user manipulation of the power button 14.

In the embodiment, for example, a display control is performed when the CPU 101 causes execution of programs stored in the system memory 103, the HDD 109, or the like.

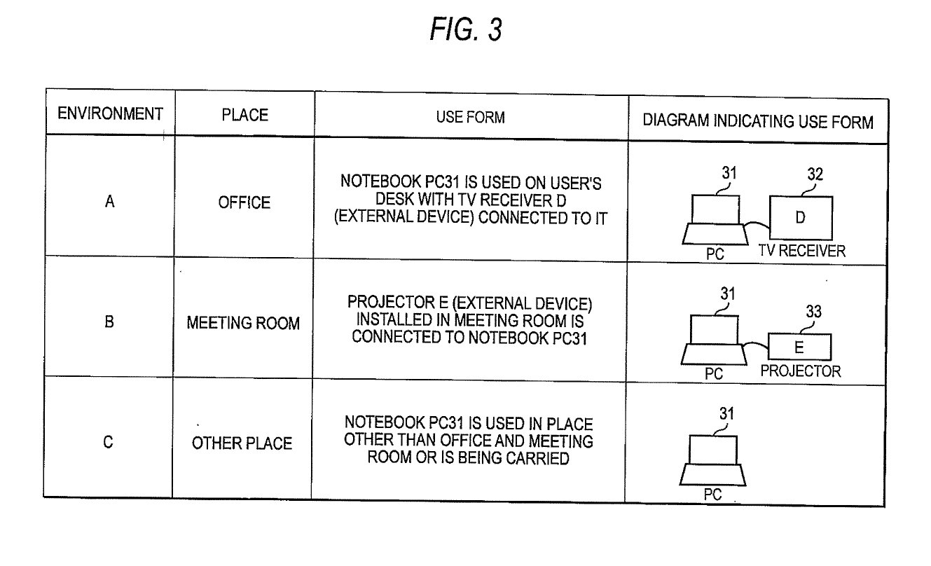

FIG. 3 shows example use forms of the notebook PC according to the embodiment. FIG. 3 shows that different external peripheral devices are connected to and disconnected from the notebook PC 31 in plural use environments.

A description will be made of an example case in which a user moves between an office and a meeting room carrying the notebook PC 31. In this example, environment A, environment B, and environment C are defined as example environments where the notebook PC 31 is placed.

In environment A (first definition), the use place is an office and the use form is “the notebook PC 31 is used on a user's desk with a TV receiver D (external device) connected to it.” That is, as shown in FIG. 3, a TV receiver D 32 is connected to the notebook PC 31.

In environment B (second definition), the use place is a meeting room and the use form is “a projector E (external device) installed in a meeting room is connected to the notebook PC 31.” That is, as shown in FIG. 3, a projector E 33 is connected to the notebook PC 31.

In environment C (third definition), the use place is a place other than the office and the meeting room and the use form is “the notebook PC 31 is used in a place other than the office and the meeting room or is being carried.” As shown in FIG. 3, neither the TV receiver D 32 nor the projector E 33 is connected to the notebook PC 31.

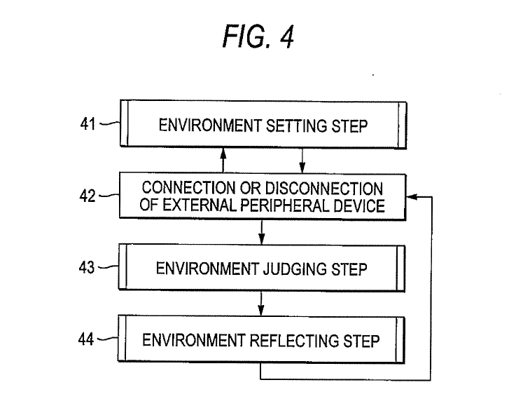

FIG. 4 shows an operation of the notebook PC 31 according to the embodiment.

At step S41, environments (e.g., environments A, B, and C shown in FIG. 3) are defined.

At step S42, an external device such as the TV receiver D 32 or the projector E 33 is connected to or disconnected from the notebook PC 31 in the office, the meeting room, or another place.

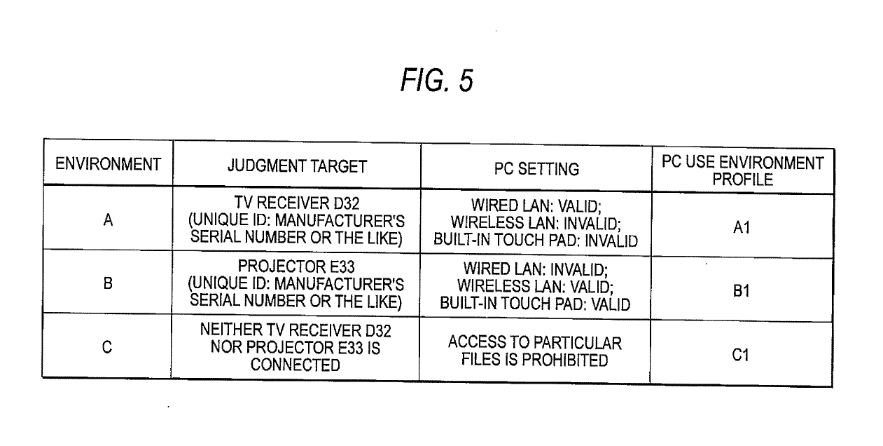

At step S43, if an external device is connected to or disconnected from the notebook PC 31, a current use environment is judged using a preset data table (described later with reference to FIG. 5), for example.

At step S44, preset PC settings are employed according to the thus-determined current use environment, that is, the current use environment is reflected in the notebook PC 31.

That is, a control method according to the embodiment includes: an environments defining step of storing, as conditions, descriptions of environments (e.g., environments A, B, and C) and also storing sets of PC settings to be employed when the respective conditions are satisfied; an environment judging step of judging whether or not one of the conditions that were set at the environment defining step is satisfied when an external device such as the TV receiver D 32 or the projector E 33 is connected to or disconnected from the notebook PC 31; and an environment reflecting step which, if the environment judging step judges that one of the conditions is satisfied, reflects, in the notebook PC 31, corresponding PC settings that were stored in the environment defining step.

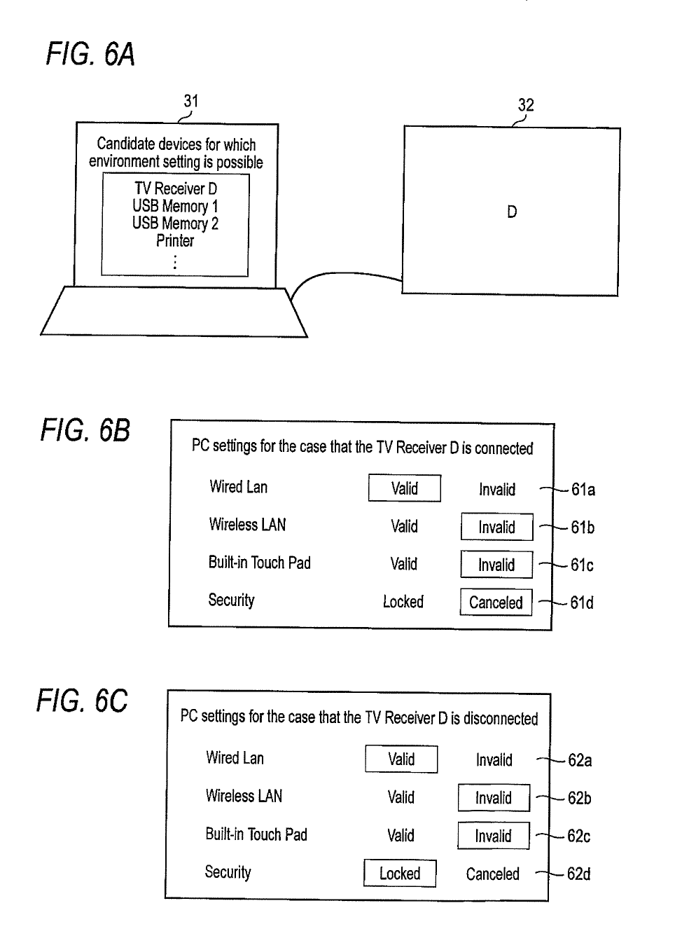

FIG. 5 shows a data table which is stored in a storage unit (e.g., EEPROM 114) of the notebook PC 31 according to the embodiment. The contents of the data table can be set and altered in manners shown in FIGS. 6A-6C (described later).

For example, in the case of environment A, PC settings relating to a use form that the TV receiver D 32 is connected to the notebook PC 31 are stored. The term “PC settings” means various settings relating to use of the notebook PC 31.

In the embodiment, the notebook PC 31 judges that it is in environment A when the TV receiver D 32 is connected. The judgment is performed using a unique ID (e.g., manufacturer's serial number) that enables identification of an individual product of the external device (TV receiver D 32). For example, when the TV receiver D 32 is connected to the notebook PC 31, the notebook PC 31 judges that it is in environment A using the unique ID (e.g., manufacturer's serial number) of the TV receiver D 32.

As shown in FIG. 5, a use environment profile “A1” is set in advance for environment A. The PC settings of the use environment profile A1 are “wired LAN: valid; wireless LAN: invalid; and built-in touch pad: invalid.”

Likewise, when the projector E 33 is connected to the notebook PC 31, the notebook PC 31 judges that it is in environment B using the unique ID (e.g., manufacturer's serial number) of the projector E 33.

As shown in FIG. 5, a use environment profile “B1” is set in advance for environment B. The PC settings of the use environment profile B1 are “wired LAN: invalid; wireless LAN: valid; and built-in touch pad: valid.”

If neither the TV receiver D 32 nor the projector E 33) is connected to the notebook PC 31, the notebook PC 31 judges that it is in environment C.

As shown in FIG. 5, a use environment profile “C1” is set in advance for environment C. The PC settings of the use environment profile C1 are “access to particular files is prohibited.”

FIGS. 6A-6C show how PC settings are made when an external device is connected to or disconnected from the notebook PC 31. This example is directed to a case that the TV receiver D 32 is connected to or disconnected from the notebook PC 31.

As shown in FIG. 6A, environment setting according to the embodiment is performed in a state that the TV receiver D 32 is connected to the notebook PC 31.

When the TV receiver D 32 is connected to the notebook PC 31, a list of candidate devices for which environment setting can be performed is displayed on the LCD 17, for example, in a manner shown in FIG. 6A.

The user specifies a device for which environment setting should be made from the candidate device list. In this example, the user designates the TV receiver D 32.

Then, as shown in FIG. 6B, a picture entitled “PC settings for the case that the TV receiver D is connected” is displayed on the LCD 17, for example. In this example, the picture allows the user to make, as PC settings, a wired LAN setting, a wireless LAN setting, a built-in touch pad setting, and a security setting. The PC setting items of this case are not limited to the ones shown in FIG. 6B and may include other items.

In the example of FIG. 6B, PC settings made by the user through designation are “valid” (61a) for wired LAN, “invalid” (61b) for wireless LAN, “invalid” (61c) for built-in touch pad 16, and “canceled” (61d) for security setting.

Then, a transition is made to environment setting for a case that the TV receiver D 32 is disconnected from the notebook PC 31.

As shown in FIG. 6C, a picture entitled “PC settings for the case that the TV receiver D is disconnected” is displayed on the LCD 17, for example. In this example, the picture allows the user to make, as PC settings, a wired LAN setting, a wireless LAN setting, a built-in touch pad setting, and a security setting. The PC setting items of this case are not limited to the ones shown in FIG. 6C and may include other items.

In the example of FIG. 6C, PC settings made by the user through designation are “valid” (62a) for wired LAN, “invalid” (62b) for wireless LAN, “invalid” (62c) for built-in touch pad 16, and “locked” (62d) for security setting.

The PC settings made as shown in FIG. 6B or 6C can be altered when necessary.

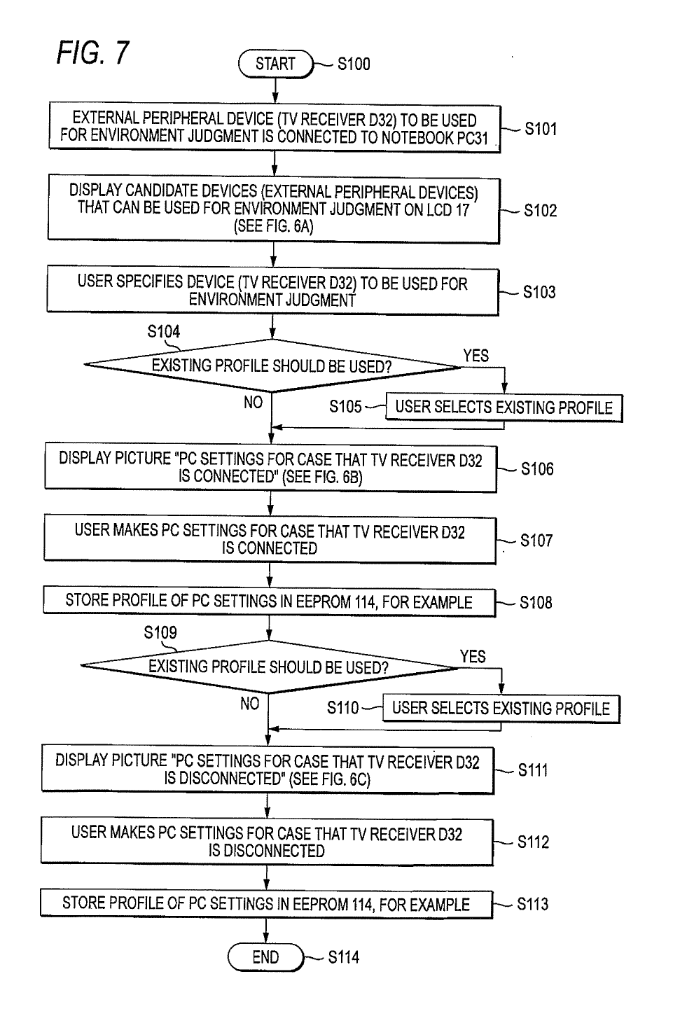

FIG. 7 shows an environment setting operation of the notebook PC 31 which is performed when the TV receiver D 32 is connected to or disconnected from it.

The process starts at step S100. At step S101, the TV receiver D 32 to be used for environment judgment is connected to the notebook PC 31.

At step S102, as shown in FIG. 6A, the notebook PC 31 displays, on the LCD 17, candidate devices (external peripheral devices) that can be used for environment judgment.

At step S103, the user specifies a device (external peripheral device; in this example, TV receiver D 32) to be used for environment judgment.

At step S104, the user makes an instruction as to whether to use an existing profile. The process moves to step S105 if an instruction to use an existing profile is made (S104: yes). If not (S104: no), the process moves to step S106.

At step S105, the user selects an existing profile (PC settings) stored in the EEPROM 114, for example.

At step S106, the picture “PC settings for the case that the TV receiver D is connected” (see FIG. 6B) is displayed.

At step S107, the user makes PC settings for the case that the TV receiver D 32 is connected to the notebook PC 31.

At step S108, the PC settings made are stored as a profile in the EEPROM 114, for example. If an existing profile has been used and altered, the user makes a selection as to whether or not a new profile should overwrite the existing one. If a new profile should overwrite the existing one, overwriting is performed. If a new profile should not overwrite the existing one or no existing profile was used, a new profile is stored as a separate profile.

Then, the process moves to step S109 to perform environment setting for the case that the TV receiver D 32 is disconnected from the notebook PC 31. At step S109, the user makes an instruction as to whether to use an existing profile. The process moves to step S110 if an instruction to use an existing profile is made (S109: yes). If not (S109: no), the process moves to step S111.

At step S110, the user selects an existing profile. At step S111, the picture “PC settings for the case that the TV receiver D is disconnected” (see FIG. 6C) is displayed.

At step S112, the user makes PC settings for the case that the TV receiver D 32 is disconnected from the notebook PC 31.

At step S113, the PC settings made are stored as a profile in the EEPROM 114, for example. The process is finished at step S114.

In the above-described process, to set a use environment in the office (environment A), the TV receiver D 32 is designated as an external peripheral device to be used for environment judgment. PC settings are made in a state that the TV receiver D 32 is connected to the notebook PC 31 (environment A). The PC settings thus made for environment A are stored as a profile A1. Likewise, PC settings for an environment in which the TV receiver D 32 is disconnected from the notebook PC 31 (environment C) are set and stored as a profile C1.

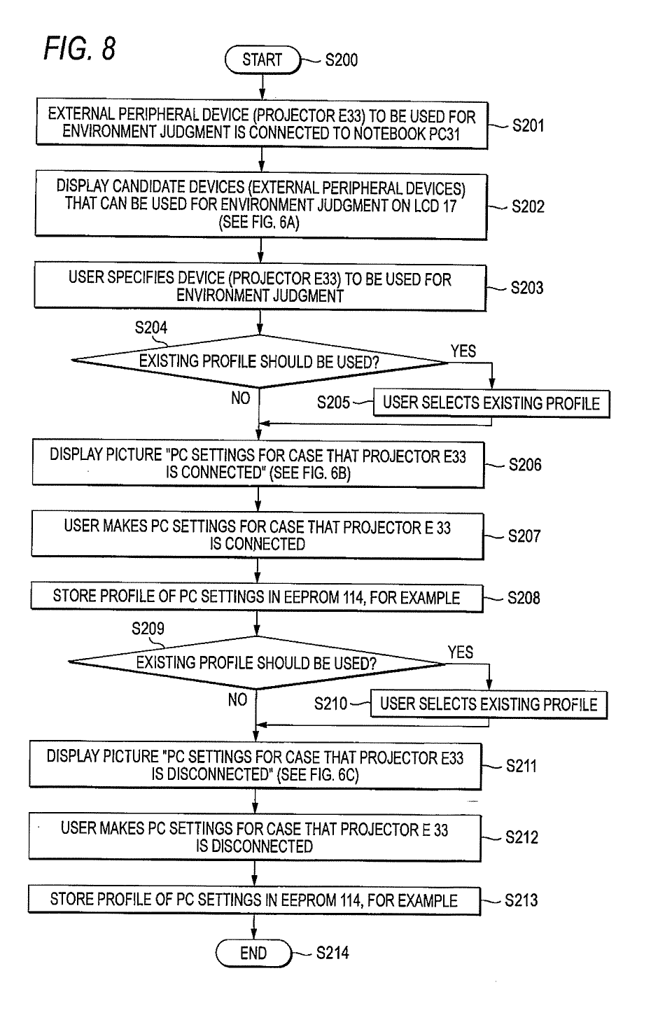

FIG. 8 shows an environment setting operation of the notebook PC 31 which is performed when the projector E 33 is connected to or disconnected from it.

At step S201, the TV receiver D 32 to be used for environment judgment is connected to the notebook PC 31.

At step S202, the notebook PC 31 displays, on the LCD 17, candidate devices (external peripheral devices) that can be used for environment judgment.

At step S203, the user specifies a device (external peripheral device; in this example, projector E 33) that can be used for environment judgment.

At step S204, the user makes an instruction as to whether to use an existing profile. The process moves to step S205 if an instruction to use an existing profile is made (S204: yes). If not (S204: no), the process moves to step S206.

At step S205, the user selects an existing profile.

At step S206, the picture “PC settings for the case that the projector E is connected” is displayed.

At step S207, the user makes PC settings for the case that the projector E 33 is connected to the notebook PC 31.

At step S208, the PC settings made are stored as a profile in the EEPROM 114, for example. Then, the process moves to step S209 to perform environment setting for the case that the projector E 33 is disconnected from the notebook PC 31.

At step S209, the user makes an instruction as to whether to use an existing profile. The process moves to step S210 if an instruction to use an existing profile is made (S209: yes). If not (S209: no), the process moves to step S211.

At step S210, the user selects an existing profile. At step S211, the picture “PC settings for the case that the projector E” is displayed.

At step S212, the user makes PC settings for the case that the projector E 33 is disconnected from the notebook PC 31.

At step S213, the PC settings made are stored as a profile in the EEPROM 114, for example. The process is finished at step S214.

In the above-described process, to set a use environment in a meeting room (environment B), the projector E 33 is designated as an external peripheral device to be used for environment judgment. PC settings are made in a state that the projector E 33 is connected to the notebook PC 31 (environment B). The PC settings thus made for environment B are stored as a profile B 1. Likewise, PC settings for an environment in which the projector E 33 is disconnected from the notebook PC 31 (environment C) are set and stored as a profile C1.

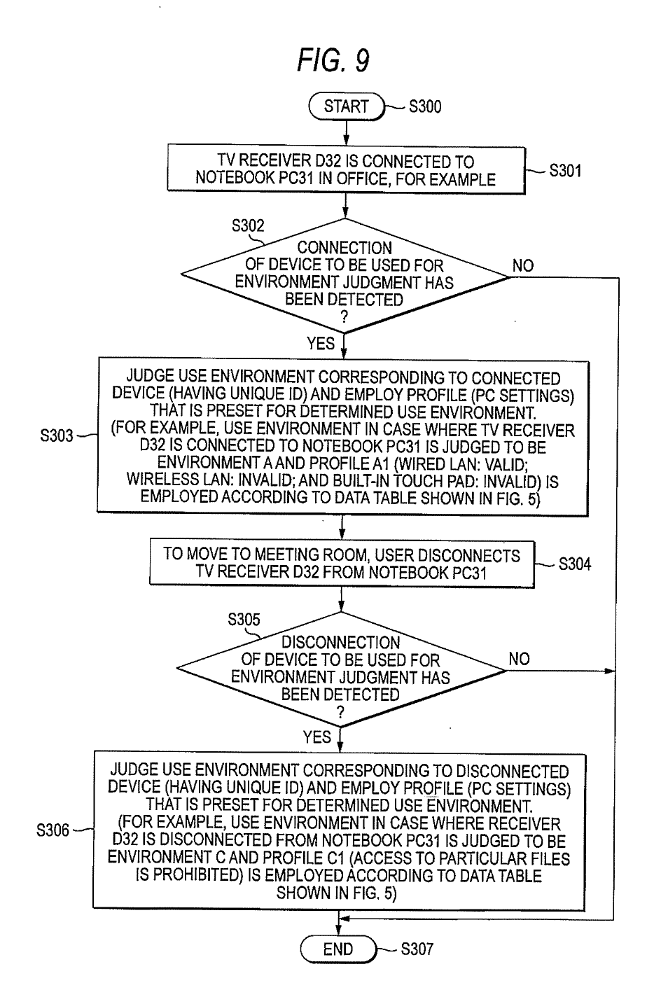

FIG. 9 shows an operation of the notebook PC 31 which is performed when the TV receiver D 32 is connected or disconnected from it.

At step S301, the TV receiver D 32 is connected to the notebook PC 31 in the office, for example.

At step S302, it is judged whether connection of a device (external peripheral device) to be used for environment judgment has been detected or not. If it is judged that connection of a device to be used for environment judgment has been detected (S302: yes), the process moves to step S303. If not (S302: no), the process moves to step S307.

At step S303, a use environment corresponding to the connected device (having a unique ID) is judged and a profile (PC settings) that is preset for the determined use environment is employed. For example, the use environment in the case where the TV receiver D 32 is connected to the notebook PC 31 is judged to be environment A and the profile A1 (wired LAN: valid; wireless LAN invalid; and built-in touch pad: invalid) is employed according to the data table shown in FIG. 5.

At step S304, to move to the meeting room, the user disconnects the TV receiver D 32 from the notebook PC 31. At step S305, it is judged whether disconnection of a device (external peripheral device) to be used for environment judgment has been detected or not. If it is judged that disconnection of a device to be used for environment judgment has been detected (S305: yes), the process moves to step S306. If not (S305: no), the process moves to step S307.

At step S306, a use environment corresponding to the disconnected device (having a unique ID) is judged and a profile (PC settings) that is preset for the determined use environment is employed. For example, the use environment in the case where the TV receiver D 32 is disconnected from the notebook PC 31 is judged to be environment C and the profile C1 (access to particular files is prohibited) is employed according to the data table shown in FIG. 5. The process is finished at step S307.

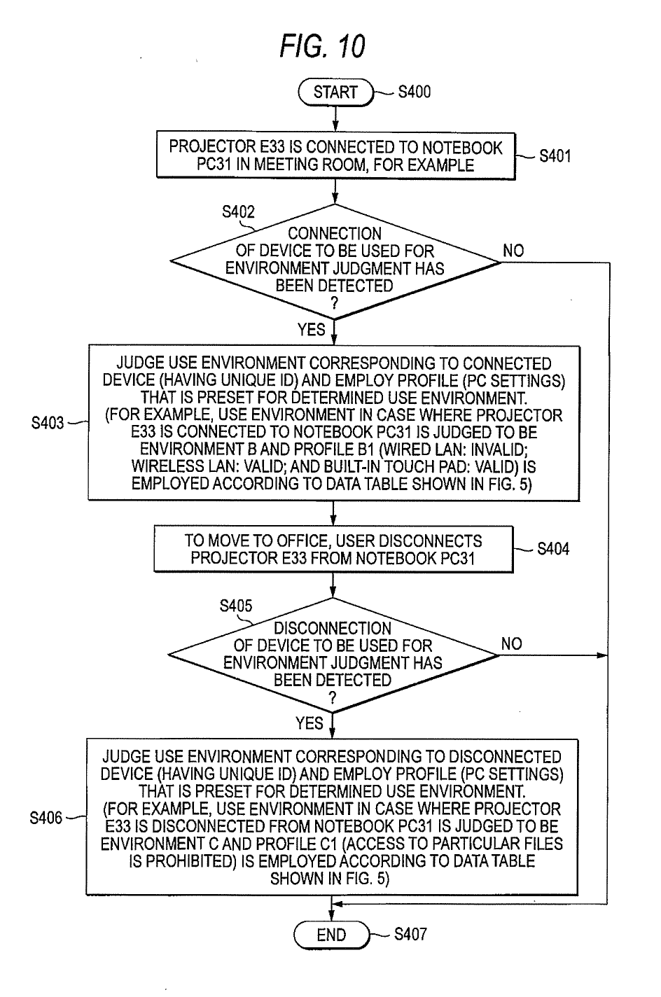

FIG. 10 shows an operation of the notebook PC 31 which is performed when the projector E 33 is connected or disconnected from it.

At step S401, the projector E 33 is connected to the notebook PC 31 in the meeting room, for example.

At step S402, it is judged whether connection of a device (external peripheral device) to be used for environment judgment has been detected or not. If it is judged that connection of a device to be used for environment judgment has been detected (S402: yes), the process moves to step S403. If not (S402: no), the process moves to step S407.

At step S403, a use environment corresponding to the connected device (having a unique ID) is judged and a profile (PC settings) that is preset for the determined use environment is employed. For example, the use environment in the case where the projector E 33 is connected to the notebook PC 31 is judged to be environment B and the profile B1 (wired LAN: invalid; wireless LAN valid; and built-in touch pad: valid) is employed according to the data table shown in FIG. 5.

At step S404, to move to the office, the user disconnects the projector E 33 from the notebook PC 31. At step S405, it is judged whether disconnection of a device (external peripheral device) to be used for environment judgment has been detected or not. If it is judged that disconnection of a device to be used for environment judgment has been detected (S405: yes), the process moves to step S406. If not (S405: no), the process moves to step S407.

At step S406, a use environment corresponding to the disconnected device (having a unique ID) is judged and a profile (PC settings) that is preset for the determined use environment is employed. For example, the use environment in the case where the projector E 33 is disconnected from the notebook PC 31 is judged to be environment C and the profile C1 (access to particular files is prohibited) is employed according to the data table shown in FIG. 5. The process is finished at step S407.

In the embodiment, once use environments of the notebook PC 31 are stored by the environments defining step S41, various settings of the notebook PC 31 are made automatically by the environment judging step S43 and the environment reflecting step S44.

If the TV receiver D 32 is connected to the notebook PC 31 in, for example, the office, the connection is detected. The PC use environment is judged to be environment A and the profile A1 is employed, whereby wired LAN is made valid, wireless LAN is made invalid, and the built-in touch pad 16 is made invalid.

If the TV receiver D 32 is disconnected from the notebook PC 31 to move to the meeting room, the disconnection is detected. The PC use environment is judged to be environment C and the profile C1 is employed, whereby access to particular files is prohibited.

If the projector E 33 is connected to the notebook PC 31 in, for example, the meeting room, the connection is detected. The PC use environment is judged to be environment B and the profile B1 is employed, whereby wired LAN is made invalid, wireless LAN is made valid, the built-in touch pad 16 is made valid, and access to the particular files is permitted again.

An electronic apparatus according to the embodiment is equipped with a connection detecting module (CPU 101) for detecting whether or not a preset external device has been connected to the electronic apparatus; and a first applying module (CPU 101) for judging a use environment and employing corresponding, preset first PC settings according to a preset data table (see FIG. 5) if connection of a preset external device is detected.

The electronic apparatus is further equipped with a disconnection detecting module (CPU 101) for detecting whether or not the external device has been disconnected from the electronic apparatus; and a second applying module (CPU 101) for judging a use environment and employing corresponding, preset second PC settings according to the preset data table if disconnection of the preset external device is detected.

The electronic apparatus is further equipped with a setting module (see FIGS. 6A-6C) for allowing a user to make PC settings to be employed when the external device is connected to or disconnected from the electronic apparatus.

The electronic apparatus is further equipped with a storage unit (EEPROM 114) for storing the preset data table.

The connection detecting module or the connection detecting module and the disconnection detecting module use a unique ID of the external device in detecting whether or not the external device has been connected to or disconnected from the electronic apparatus.

The first PC settings or the first PC settings and the second PC settings can be altered.

Another embodiment is possible in which more detailed PC setting can be made by designating plural peripheral devices as the judgment targets.

The concept of the above-described embodiment can be implemented as software or an external peripheral device which incorporates functions relating to the concept of the above-described embodiment. In this case, the embodiment can make less troublesome work of altering the PC settings of an electronic apparatus according to a change in its use environment.

All the steps of each control process according to the embodiment can be implemented by software. Therefore, the advantages of the embodiment can easily be obtained merely by installing programs of the control processes in an ordinary computer via a computer-readable storage medium that is stored with the programs and running the installed programs.

The invention is not limited to the above embodiment itself and, in the practice stage, may be embodied in such a manner that constituent elements are modified in various manners without departing from the spirit and scope of the invention. And various inventive concepts may be conceived by properly combining plural constituent elements disclosed in the embodiment. For example, several ones of the constituent elements of the embodiment may be omitted.

1. An electronic apparatus, comprising:
a connection detecting module configured to detect a connection of a preset external device to the electronic apparatus; and
a first applying module configured to employ a preset first setting according to a preset data table upon the connection of the preset external device, the preset data table correlating the preset first setting with the connection of the preset first external device.

2. The apparatus of claim 1, further comprising:
a disconnection detecting module configured to detect a disconnection of the preset external device from the electronic apparatus; and
a second applying module configured to employ a preset second setting according to the preset data table upon the disconnection of the preset external device, the preset data table correlating the preset second setting with the disconnection of the preset first external device.

3. The apparatus of claim 1, further comprising:
a setting module configured to allow a user to correlate a preset setting and a connection or a disconnection of an external device to or from the electronic apparatus.

4. The apparatus of claim 1, further comprising:
a storage unit configured to store the preset data table.

5. The apparatus of claim 1,
wherein the connection detecting module detects the connection of the preset external device based on a unique ID of the preset external device.

6. The apparatus of claim 1,
wherein the preset first setting is alterable.

7. A control method of an electronic apparatus, the method comprising:
detecting a connection of a preset external device to the electronic apparatus; and
employing a preset first setting according to a preset data table upon the connection of the preset external device, the preset data table correlating the preset first setting with the connection of the preset first external device.

8. A control program for controlling an electronic apparatus, causing the electronic apparatus a process, the process comprising:
detecting a connection of a preset external device to the electronic apparatus; and
employing a preset first setting according to a preset data table upon the connection of the preset external device, the preset data table correlating the preset first setting with the connection of the preset first external device.
